(19) United States
(12) Patent Application Publication
(10) Pub. No.: US 2019/0257397 A1
(43) Pub. Date: Aug. 22, 2019

(54) COUPLING ASSEMBLY AND METHOD OF COUPLING

(71) Applicant: Wilkins IP, LLC, New Albany, IN (US)

(72) Inventors: Stephen Wilkins, Floyds Knobs, IN (US); Larry Wilkins, Fort Lauderdale, FL (US)

(21) Appl. No.: 15/900,849

(22) Filed: Feb. 21, 2018

(51) Int. Cl. F16H 25/20

(52) U.S. Cl. CPC F16H 25/2015; F16H 2025/209; F16H 2025/2031

(57) ABSTRACT

A coupling assembly includes a first shaft, a first housing configured to receive the first shaft, a second housing configured to attach to the first housing, a first gear positioned in the second housing and engaged with the first shaft, a first bearing positioned between the first gear and the second housing, a third housing, a second gear positioned in the third housing and engaged with the first gear, a second shaft that extends through the third body and engages the second gear, and a second bearing positioned between the second shaft and a wall of the third housing. The second shaft may rotate relative to the third housing and cause the first gear to drive the first shaft in an axial movement relative to the first housing and the second housing.

### TECHNICAL FIELD

The present disclosure relates generally to coupling assemblies that couple two or more loads together in tension. More specifically, the present disclosure relates to a coupling assembly that includes a drive assembly that drives an axial movement of a shaft with rotational movements of gears, and a bearing arrangement that minimizes a transmission of rotational and axial movements to housings of the coupling assembly.

### BACKGROUND

Coupling assemblies are often used to join lines, such as cables, attached to heavy loads. Gear arrangements of such coupling assemblies are often used to facilitate the use of a less powerful input force or prime mover to perform tasks on the heavy loads. The gear arrangements may also reduce output speed based on the input of a prime mover having an undesirably high output speed. Example implementations of coupling assemblies provided with a gear arrangement that facilitate the performance of tasks on heavy loads include turnbuckles or load binders. For example, a turnbuckle may be used to adjust a tension between, and/or a total length of, lines attached to heavy loads using a hand-operated tool, such as a wrench, or a motor operated tool, such as a power driver.

Coupling assemblies as discussed herein may be used when transporting solid and/or liquid cargo via barges along bodies of water. The use of barges to transport cargo has become increasingly attractive due to an increase in a desire to transport cargo more efficiently and with less undesirable emissions. Recent studies indicate that transport of cargo by barge is more than 25% more efficient than transport by rail and more than three times as efficient as transport by truck. In addition, transport of cargo by barge results in significantly less undesirable emissions than transport by rail and truck.

In order to increase the efficiency of transport of cargo via barges, a number of barges may be grouped together in a barge “train” or “tow” by cables and pushed or pulled by a single or several boats. For example, as many forty barges may be held together in a group of five rows by eight rows. In such barge “trains” or “tows,” it may be desirable to adjust the tension and/or length of the cables holding the barges together to facilitate control of the barges during the release or addition of barges from the group, or during navigation of a waterway. Coupling assemblies, such as turnbuckles or load binders, are often used for facilitating such adjustments.

However, especially in the case of a power driver, it is often the case that a tool used to operate such a coupling assembly will have a tendency to become misplaced and disengaged from the coupling assembly due to forces generated by movements of components of a respective gear arrangement within the coupling assembly. In particular, such movements may generate forces that are transmitted to the housing or casing of the coupling assembly and cause the entire assembly to move away from the tool being used to adjust the coupling assembly. Thus, continued adjustment of the coupling assembly may require an operator to perform a physically-demanding task of attempting to hold the coupling assembly in place so a tool remains engaged with the coupling assembly. Moreover, the design of such turnbuckles can be cumbersome as they may comprise a lever arm or handle bar that provides a gripping location for the operator to prevent the coupling assembly from rotating or twisting during use.

These and other issues are solved by a coupling assembly and method of coupling loads with the coupling assembly, of the present disclosure.

### SUMMARY

According to certain aspects of the present disclosure, a coupling assembly may include a first shaft, a first housing including a first housing body that defines a first housing cavity that may be configured to receive the first shaft, and a second housing including a second housing body that may define a second housing bore, the second housing may be configured to attach to the first housing. According to another aspect of the present disclosure, the coupling assembly may include a first gear that is positioned in the second housing bore and may be configured to engage the first shaft proximate to the first housing cavity, a first bearing positioned between the first gear and the second housing body within the second housing bore, a third housing including a third housing body that may define a main cavity and at least one peripheral cavity, a second gear that is positioned in the main cavity and may be configured to engage the first gear, and a second shaft extending through the main cavity and the at least one peripheral cavity, the second shaft may be configured to engage the second gear. According to another aspect of the present disclosure, the coupling assembly may include a second bearing positioned between the second shaft and a wall of the third housing body that may define one of the main cavity and the at least one peripheral cavity. According to a further aspect of the present disclosure, the second shaft may rotate relative to the third housing and cause the first gear to drive the first shaft in an axial movement relative to the first housing and the second housing.

According to certain aspects of the present disclosure, a method of coupling two loads includes providing a coupling assembly, attaching a first housing of the coupling assembly to one of the two loads, attaching a first shaft of the coupling assembly to the other of the two loads, and operating a drive assembly of the coupling assembly to adjust a tension between the two loads. According to another aspect of the present disclosure, providing the coupling assembly may include providing a second housing attached to the first housing, a first gear positioned in the second housing, a threaded engagement between the first shaft and the first gear, a first bearing that is positioned between the first gear and an inner circumferential wall of the second housing and may be configured to support a rotation of the first gear relative to the second housing, a third housing attached to the second housing, a second gear that is positioned in the third housing and may be engaged with the first gear through a gear slot defined by the second housing, and at least one bearing positioned between a second shaft of the drive assembly and a recessed wall of the second housing. According to another aspect of the present disclosure, operating the drive assembly may include rotating the second shaft of the drive assembly.

According to cert aspects of the present disclosure, a coupling assembly may include a first shaft including a threaded external surface and a threaded internal surface, a plug including a plug head and a threaded body engaged with the threaded internal surface, a first housing including a first housing body that defines a first housing cavity configured to receive the first shaft, a second housing including a second housing body that defines a second housing bore, a first gear positioned in the second housing bore and engaged with the threaded external surface, and a first bearing positioned between the first gear and the second housing body within the second housing bore. According to another aspect of the present disclosure, the coupling assembly may include a third housing including a third housing body that defines a main cavity and a peripheral cavity on opposite sides of the main cavity, a second gear positioned in the main cavity and engaged with the first gear, a second shaft extending through the main cavity and each peripheral cavity and being engaged with the second gear, and a pair of bearings positioned in the third housing, each of the pair of bearings may be positioned in a respective peripheral cavity between the second shaft and third housing body. According to another aspect of the present disclosure, the second shaft may rotate relative to the third housing and cause the first gear to drive the first shaft in an axial movement relative to the first housing and the second housing. According to a further aspect of the present disclosure, the plug may be configured to slide relative to the first housing, and a rim of the plug head may engage an inner circumferential wall of the first housing and have a diameter greater than an outer diameter of the external threaded surface of the first shaft.

### BRIEF DESCRIPTION OF THE DRAWINGS

FIGS. 1A and 1B illustrate perspective views of a coupling assembly, according to an aspect of the present disclosure.

FIG. 2 illustrates an exploded view of a coupling assembly, according to an aspect of the present disclosure.

FIG. 3 illustrates a sectional view of the coupling assembly of FIG. 1A, taken upon a plane indicated by section line 3-3.

FIG. 4A illustrates a sectional view of the coupling assembly of FIG. 1A, taken upon a plane indicated by section line 4-4.

FIG. 4B illustrates a sectional view of an implementation of the coupling assembly of FIG. 1A, taken upon the plane indicated by section line 4-4.

FIG. 5 is a flowchart illustrating an exemplary method of implementing a coupling assembly, according to an aspect of the present disclosure.

FIG. 6 illustrates a perspective view of a coupling assembly, according to an aspect of the present disclosure.

### DETAILED DESCRIPTION

Aspects of the disclosure will now be described in detail with reference to the figures, wherein like reference numbers refer to like elements throughout, unless specified otherwise. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. For the purposes of this disclosure and unless otherwise specified, “a” or “an” means “one or more”. Still further, using “and” or “or” in the detailed description is intended to include “and/or” unless specifically indicated otherwise.

Aspects of the present disclosure described herein are directed toward a coupling assembly that may include a first shaft, a first housing including a first housing body that defines a first housing cavity that may receive the first shaft, a second housing including a second housing body that may define a second housing bore, a first gear that is positioned in the second housing bore and may engage the first shaft, and a first bearing positioned between the first gear and the second housing body within the second housing bore. The coupling assembly may include a drive assembly provided with a third housing, a second shaft that extends through a main cavity and peripheral cavities defined by a third housing body, and a second gear that may be positioned in the main cavity and configured to engage the first gear through a gear slot defined by the second housing body. The drive assembly may further include at least one bearing, or a plurality of bearings according to an aspect of the present disclosure, that supports rotational movement and/or limits an axial displacement of the second shaft and the second gear. Rotation of the first gear by the second gear, which may be driven by a tool rotating the second shaft, rotates a threaded engagement between the first gear and the first shaft such that a threaded inner surface of the first gear axially displaces a thread outer surface of the first shaft, and drives an axial movement of the first shaft.

The plurality of bearings in the third housing can optimize a transmission of a driving force that rotates the first gear, and at the same time prevents the movements of the second shaft and the second gear from being transmitted to the first, second, and third housings. The first bearing provided in the second housing supports the rotation of the first gear and serves as a buffer between an inner circumferential wall of the second housing and outer most surfaces of the first gear and the first shaft. Accordingly, the rotational movement of the first gear, and the axial movement of the first shaft, are not transmitted to the second housing or the first housing which is attached to the first housing.

The arrangement of bearings in the coupling assembly may isolate the first and second housings from the movements of the first gear, the second gear, and the first shaft. As a result, the coupling assembly will not be subject to vibrations or other movements of its internal components that may complicate keeping the coupling assembly in a position to remain engaged with a tool, in particular a power driver, and be continuously operated. More generally, the coupling assembly according to the present disclosure will not move away from the tool to the point of disengagement as a result of the movements of the components of the coupling assembly. As such, no lever arm or handle bar is needed for gripping by an operator to prevent the coupling assembly from rotating or twisting during use. Thus, the coupling assembly can be less cumbersome, weigh less, and less likely to snag on obstacles than coupling assemblies that require a lever arm or handle bar to prevent twisting.

### Coupling Assembly

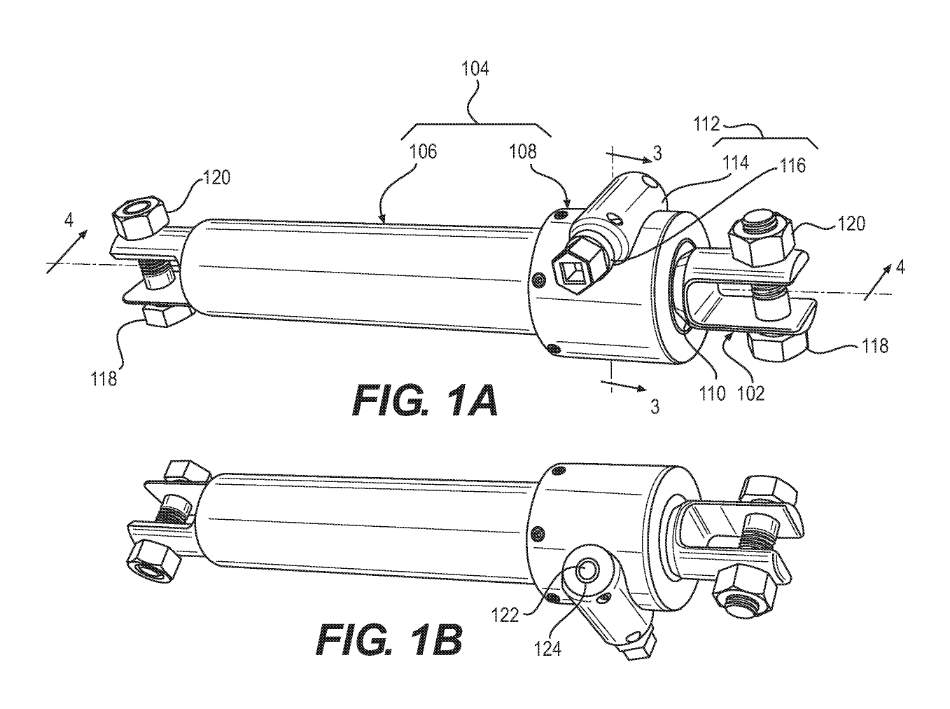

FIGS. 1A and 1B illustrate perspective views of a coupling assembly 100, according to an aspect of the present disclosure. As illustrated in FIG. 1A, the coupling assembly 100 may include a first shaft 102, and a combined shaft housing 104 that may receive and engage the first shaft 102. In particular, the first shaft 102 may be received in a first housing 106 and a second housing 108, and a first gear 110 provided in the second housing 108 may engage the first shaft 102. The first gear 110 may have an exposed end 111 such that an engagement between the first gear 110 and the first shaft can be seen at an end of the second housing 108. The coupling assembly 100 may further include a drive assembly 112 including a third housing 114 and a second shaft 116. Screws 118 may be secured by nuts 120 to each of the first housing 106 and first shaft 102, and used with the coupling assembly to couple heavy loads such as barges, for example.

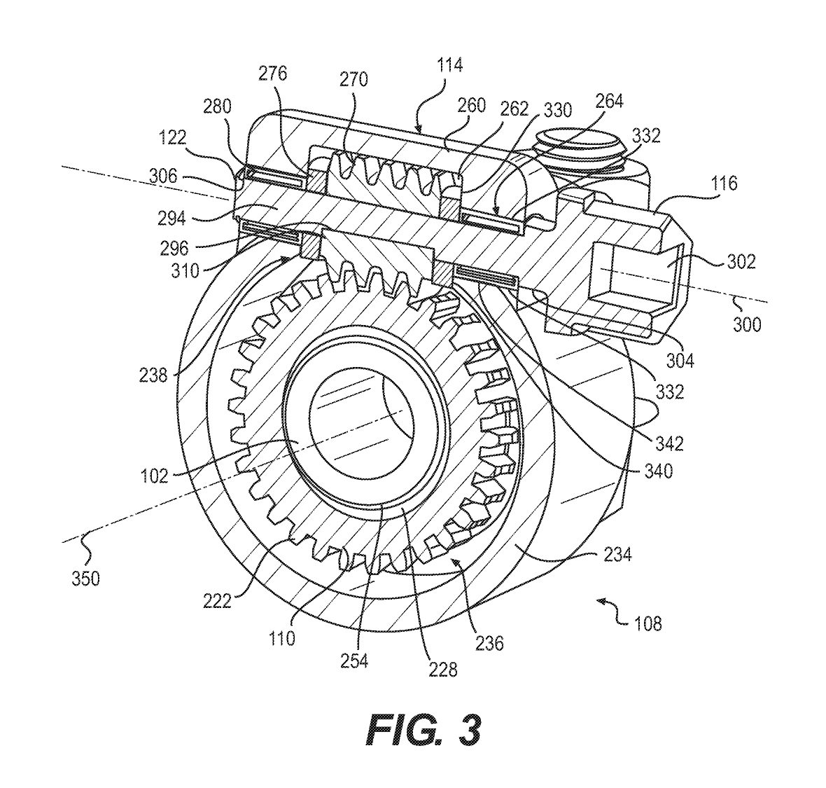

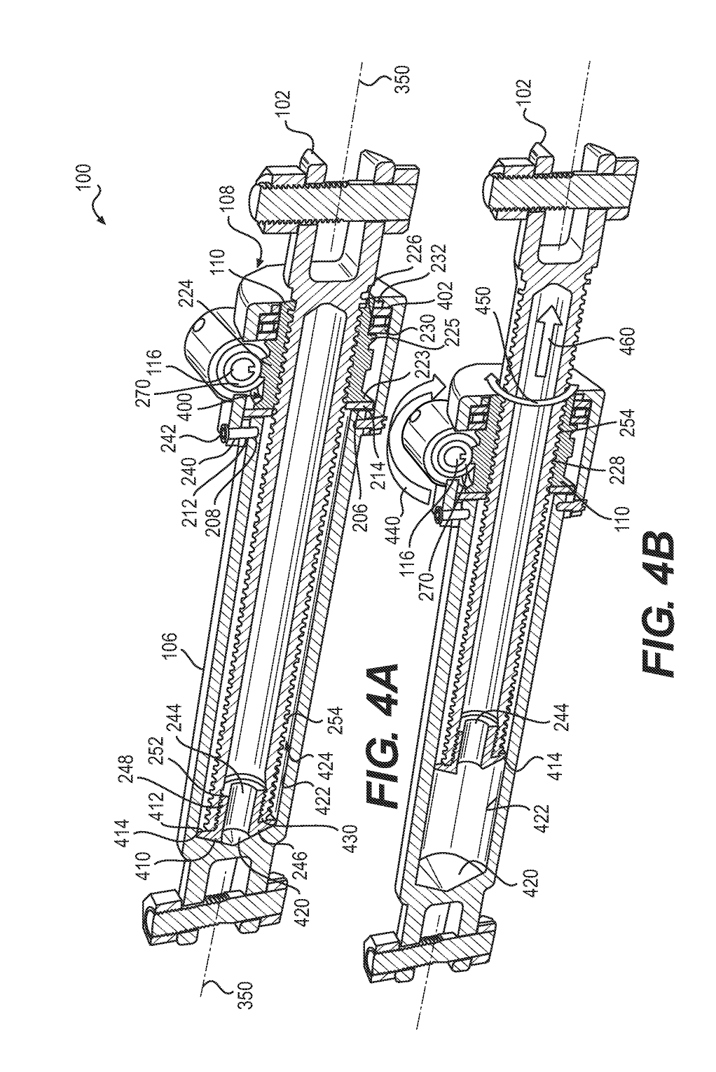

FIG. 1B illustrates the coupling assembly 100 rotated from an orientation illustrated in FIG. 1A, and shows an end of the third housing 112 opposite to an end shown in FIG. 1A. As illustrated in FIG. 1B, the second shaft 116 extends through the third housing 114 and is retained in place at a distal end 122 by a retention ring 124. The retention ring 124 may aid in maintaining an axial position of the second shaft 116 relative to the third housing 114 during an operation of the coupling assembly 100 in which the second shaft 116 is driven to rotate relative to the third housing 114. As described in more detail with reference to FIGS. 3-4B, rotation of the second shaft 116 may cause the first gear 110 to rotate and thereby cause the first shaft 102 to move in a linear axial direction relative to the combined shaft housing 104 and drive assembly 112.

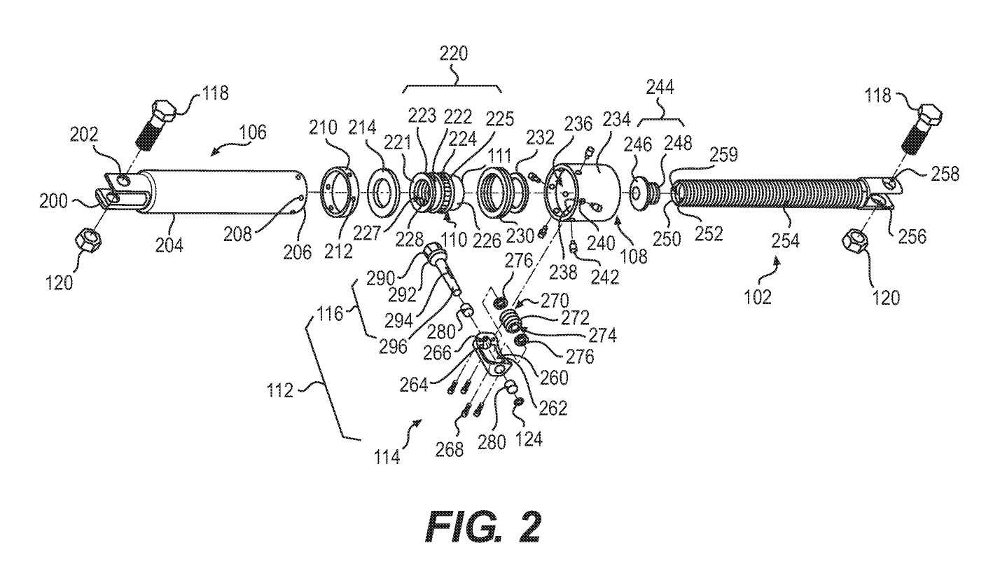

FIG. 2 illustrates an exploded view of the coupling assembly 100, according to an aspect of the present disclosure. As illustrated in FIG. 2, first housing 106 may include housing arms 200 with eyeholes 202 formed therein to receive the screw 118. A first housing body 204 may extend from the housing arms 200 and define a housing end-face 206 proximate to first attachment bores 208 also defined by the first housing body 204. A spacer 210 may be configured to fit around the first housing body 204 and positioned so that spacer bores 212 defined by the spacer 210 are aligned with to the first attachment bores 208. The spacer bores 212 being provided to facilitate an attachment between the first housing 106 and the second housing 108 proximate to the housing end-face 206.

As assembled, the housing end-face 206 may engage (e.g. abut) one side of a first washer 214 of the coupling assembly 100. An opposite side of the first washer 214 may be configured to engage an end-face 221 of a first gear body 220 of the first gear 110. The first gear body 220 may define a first cylindrical portion 222 that is disposed between a first lip 223 and a second lip 225, which may also be defined by the first gear body 220. A first gearing component 224 may be provided on (e.g. formed with, attached to) the first cylindrical portion 222 between the first lip 223 and the second lip 225.

Gearing components as defined herein may include a structural component of one gear configured to mesh with and drive or be driven by a structural component of another gear. Accordingly, a gearing component may include a plurality of teeth (helix tooth, spur tooth, bevel tooth, etc.), cogs, or a helical spiral (e.g. threads, a worm). According to an aspect of the present disclosure, the first gearing component gearing 224 may include teeth such as cylindrical or enveloping teeth, and thereby define a worm gear of a worm drive. According to an aspect of the present disclosure, the diameter of each of the first and second lips 223, 225 may be equal to or greater than a diameter of an addendum circle or outer diameter defined by the first gearing component 224.

The first gear body 220 further defines a second cylindrical portion 226 that may have an outer diameter less than that of the first cylindrical portion 222, and extend along a longitudinal axis of the first gear 110 from the second lip 225 to the exposed end 111. A first gear bore 227 of the first gear 110 is defined by a first threaded inner surface 228 of the first gear body 220, and extends from the end-face 221 to the exposed end 111. The second cylindrical portion 226 may be configured to receive or have fitted thereon a first bearing 230, and the first threaded inner surface 228 may be configured to engage the first shaft 102 as discussed in more detail herein.

As illustrated, the coupling assembly 100 further includes a second washer 232 that may engage and maintain (aid in maintaining) the first bearing 230 in a respective functional position between the second lip 225 and a wall (see FIGS. 4A and 4B) of the second housing 108. The second housing 108 includes a second housing body 234 that defines a second housing bore 236, which accommodates the first washer 214, the first gear 110, the first bearing 230, and the second washer 232 in an assembled state of the coupling assembly 100. The second housing body 234 further defines a gear slot 238 that is configured to receive certain components of the drive assembly 112; the gear slot 238 being defined as a void in the second housing body 234 in a shape of an annular segment. In addition, the second housing body 234 defines a plurality of second attachment bores 240 configured to receive first set screws 242 via a threaded engagement respectively there between.

In an assembled state of the coupling assembly 100, the first housing 106, the spacer 210, and the second housing 108 are orientated relatively so that the first attachment bores 208, the spacer bores 212, and the second attachment bores 240 are aligned so that each combination of bores may receive one or more first set screws 242. As a result, the second housing 108 may be attached to the first housing 106 with the spacer 210 positioned between an outer surface of the first housing 106 and an inner surface of the second housing 108 (see FIGS. 4A and 4B).

The coupling assembly 100 includes a plug 244 having a plug head 246 and a threaded body 248. The threaded body 248 is configured to engaged (i.e. be threaded to) a second threaded inner surface 252 defined by a first shaft body 250 of the first shaft 102. The first shaft body 250, further defining a threaded external surface 254, extends from shaft arms 256 that have eyeholes 258 formed therein to receive a respective screw or bolt 118. The second threaded inner surface 252, and a portion of an inner surface of the first shaft body 250 not including second threaded inner surface 252, define a first shaft cavity 259.

FIG. 2 further illustrates an exploded view of the drive assembly 112 which includes the third housing 114 and the second shaft 116. The third housing 114 includes a third housing body 260 that defines a main cavity 262, peripheral cavities 264, and third attachment bores 266. As illustrated, the main cavity 262 is defined between the peripheral cavities 264 along a longitudinal axis of the third housing 114, and each peripheral cavity 264 is defined between a respective pair of the third attachment bores 266. Second set screws 268 may be received in the third attachment bores 266 to directly attach the third housing 114 to the second housing 108, and thereby attach the drive assembly 112 to the second housing 108.

The main cavity 262 is configured to receive a second gear 270 between second bearings 276 that are also configured to be positioned in the main cavity 262. The second gear 270 includes a second gearing component 272 configured to engage (i.e. mesh) with the first gearing component 224 of the first gear 110. According to an aspect of the present disclosure, the second gearing component 272 may be defined by a body of the second gear 270 in a configuration of a worm (e.g. cylindrical or enveloping worm), such that the first gear 110 and the second gear 270 define a worm drive. According to another aspect of the present disclosure, the first and second gears 110, 270 may be screw gears. The body of the second gear 270 may further define a second gear bore 276 that is configured to receive the second shaft 116. The second shaft 116 may be supported for rotation within the third housing 114 by a pair of third bearings 280, each third bearing 280 being positioned in a respective peripheral cavity 264.

As illustrated in FIG. 2, the second shaft 116 includes a drive head 290, a collar 292, and a drive shaft 294. The collar 292 is disposed between the drive head 290 and the drive shaft 294. Further, a body of the drive shaft 294 defines a shaft slot 296 between the distal end 122 and the collar 292 along a longitudinal axis of the second shaft 116. The shaft slot 296 may be configured to accommodate the second gear 270 as discussed in more detail with reference to FIG. 3.

According to an aspect of the present disclosure, various components of the coupling assembly 100 may be formed from materials that are resistant to corrosion (e.g., stainless steel). For example, sub-components or the entirety of one or more of the first shaft 102, the second shaft 116, the first housing 106, the second housing 108, the third housing 114, the first gear 220, and the second gear 270 may be formed of stainless steel. According to an aspect of the present invention, incorporation of steel components in the coupling assembly 100 may provide improved resistance to corrosion as compared to other coupling assemblies known in the art. As such, the coupling assembly 100 of the present disclosure may withstand repeated use in various weather conditions with little or no change to its respective functionality, as compared to the reduced capabilities of other coupling assemblies known in the art given the same use.

According to another aspect of the present disclosure, one advantage of the construction of the coupling assembly 100 is that various components can be disassembled, and sub-components, such as the first and second washers 214, 232 and the first gear 110 relative to the second housing 108, may be easily replaced. For example, in a situation where portions of the threaded external surface 254 of the first shaft 102 have become overly worn or even stripped, the first set screws 242 may be removed and the second housing 108 detached from the first housing 106. The second housing 108 may continue to be engaged with the first shaft 102, with the plug 244 exposed and freely removable. Accordingly, the plug 244 may be rotated and detached from the first shaft 102. According to an aspect of the present invention, the second shaft 116 may then be held in place so the first gear 110 does not rotate with the first shaft 102 that is rotated and threaded out of the second housing 102 to thereby be replaced.

### Operation

An operation of the coupling assembly 100 according to the present disclosure, will be described with reference to FIGS. 3 and 4.

FIG. 3 illustrates a sectional view of the coupling assembly 100 of FIG. 1A, taken upon a plane indicated by section line 3-3. In an exemplary operation, the drive assembly 112 may be implemented by rotating the second shaft 116 about a drive axis 300, which causes the second gear 270 to rotate and drive a rotation of the first gear 110. Rotation of the first gear 110 causes the engagement between the first gear 110 and the first shaft 102 to change and results in axial movement of the first shaft 102 along a translational axis 350 illustrated in FIG. 3.

In more specific terms, a tool such as a driver or a wrench, may engage a shaped recess 302 (e.g. socket) defined by/formed within the drive head 290. The engagement with the shaped recess 302 causes a rotational movement of the tool about a drive axis 300 of the drive assembly 112 to be transferred to the second shaft 116. A stepped portion 304 of the second shaft 116 is disposed between the collar 292 and the drive shaft 294, and defines a bearing surface of the second shaft 116. More specifically, the stepped portion 304 may rotate relative to components of one of the third bearings 280. The stepped portion 304 together with the retention ring 124, which is received in a shaft groove 306 formed adjacent to the distal end 122 of the second shaft 116, locate and at least in part maintain an axial position of the drive shaft 294 with respect to the third housing 114 during rotation.

The shaft slot 296 defined by the drive shaft 294 is configured to receive a key 310 defined by a body of the second gear 270. The key 310 protrudes within the second gear bore 274 to extend along the drive axis 300; the drive shaft 294 and the second gear 270 being coaxial with the drive axis 300. It will be understood by those having ordinary skill in the art that a key may be formed to extend from the drive shaft 294 and engage in a slot defined in an inner surface of the second gear 270. In either of the configurations discussed herein, during the operation of the coupling assembly 110, the rotation of the second shaft 116 will be transmitted to the second gear 270 via an engagement between the key 310 and the shaft slot 296 such that the second gear 270 rotates about the drive axis 300.

The second bearings 276 maintain an axial position of the second gear 270 within the main cavity 262 relative to the third housing 114 during the operation of the coupling assembly 100. More specifically, each second bearing 276 is positioned between, and may engage, a respective end of the second gear 270, and a first combined wall defined by: (1) a first side wall 330 of the third housing 114; (2) an end of a respective third bearing 280; and (3) a second side wall 340 of the second housing 108. The first side wall 330 is defined by/formed within the third housing body 260, and defines in part the main cavity 262. The second side wall 340 is defined by/formed within the second housing body 234, and defines the gear slot 238 within the second housing 108.

According to an aspect of the present disclosure, the second bearings 276 may be thrust bearings (e.g. thrust ball bearings, spherical roller thrust bearings, fluid bearings, etc.) and serve as axial buffers along the drive axis 300 between the second gear 270 and the first and second side walls 330, 340. Thus, the second bearings 276 may absorb and minimize a transmission of axial movement of the second gear 270 and the second shaft 116 to the second and third housings 108, 114 during the operation of the coupling assembly 100. In addition, the second bearings 276 may be coated with a friction reducing coating, formed of a material for which a coefficient of friction therewith is small, and/or be embedded with a lubricant (e.g. oil). Accordingly, the second gear 270 may rotate relative to components of the second bearings 276, while at the same time, components of the second bearings 276 may rotate relative to a respective first combined wall. As a result, a minimal amount of the rotational movement of the second gear 270 is transmitted to the second and third housings 108, 114.

Upon the transfer of the rotational movement of a tool via the shaped recess 302, the third bearings 280 support, and more importantly facilitate, the combined rotation of the drive shaft 294 (second shaft 116) and the second gear 270 relative to the third housing 114 and the second housing 108. According to an aspect of the present disclosure, the third bearings 280 may be roller bearings (e.g. needle roller, cylindrical roller, spherical roller, etc.). Each third bearing 280 may include an outer surface (e.g. an outer surface of an outer race) that is received in and engages a respective annular wall 332 of the third housing 114, and a respective recessed wall 342 of the second housing 108. As illustrated in FIG. 3, the annular walls 332 define the peripheral cavities 264 of the third housing 114, and the recessed walls 342 are defined on opposite sides of the gear slot 238. The positioning of the third bearings 280 as described herein minimize transmission of the rotational movement of the drive shaft 294 to the second and third housings 108, 114.

The bearing arrangement limits any axial movement of the second shaft 116 and second gear 270 from the second and third housings 108, 114. In addition, the bearing arrangement optimizes an efficiency (i.e. reduces resistance to an optimal degree) of the rotational movement of the second gear 270 to drive a rotation of the first gear 110 during the operation of the coupling assembly 100.

The rotation about the drive axis 300 by the second gear 270 drives a rotation of the first gear 110 about the translational axis 350, which is transverse to the drive axis 300. As discussed above, the first gear 110 may provide a worm gear, and the second gear 270 may provide a worm, of a worm drive. Accordingly, a speed ratio between the second gear 270 and the first gear 110 may be such that the first gear 110 constitutes a speed reducing gear. For example, a single revolution of the second gear 270 may cause the second gearing component 276 (worm) to advance the first gear 110 (worm gear) only one tooth and a space of the first gearing component 224. It will be understood that different configurations of the first and second gearing components 224, 276 may be provided to obtain a desired speed reduction during the operation of the coupling assembly 100.

The rotation of the first gear 110 within the second housing bore 236 results in a progressive change in the engagement between the first threaded inner surface 228 of the first gear 110 and the threaded external surface 254 of the first shaft 102. As the first gear 110 remains in a substantially stationary position relative to the translational axis 350, the rotation of the threaded engagement between the first gear 110 and the first shaft 102 causes the first shaft 102 to progress through the first gear 110 and the second housing 108. The direction of the progression during the operation of the coupling assembly 110 is determined by a direction of rotation of second shaft 116, as discussed in more detail with reference to FIGS. 4A and 4B.

FIG. 4A illustrates a sectional view of the coupling assembly 100 of FIG. 1A, taken upon a plane indicated by section line 4-4. During the operation of the coupling assembly 100, the second gear 270 rotates, which causes a rotation of the first gear 110 and the threaded engagement between the first gear 110 and the first shaft 102. In turn, an axial movement of the first shaft 102 along the translational axis 350 is affected. The first bearing 230 facilitates the rotation of the first gear 110 relative to the second housing 108, and may include a roller bearing according to an aspect of the present disclosure.

The first bearing 230 is positioned radially between the second cylindrical portion 226 of the first gear 110, and a second inner circumferential wall 400 of the second housing 108. Outer circumferential surfaces of the first lip 223 and the second lip 225 are disposed radially inward of an engagement between the first bearing 230 and the second inner circumferential wall 400. As noted above, the diameter of each of the first and second lips 223, 225 may be equal to or greater than the diameter of an addendum circle or outer diameter defined by the first gearing component 224 of the first gear 110. Accordingly, none of the first gearing component 224, first lip 223, or the second lip 225 engages the second inner circumferential wall 400 (see also FIG. 3). Thus, as a result of a bearing arrangement of the first bearing 230, the rotational motion of the first gear 110 is not transmitted to the second housing 108.

Further, the first bearing 230 is positioned in second housing 108 as part of a configuration that limits an axial movement of the first gear 110. More specifically, the first bearing 230 is positioned on the second cylindrical portion 226 of the first gear 110 axially between the second lip 225, and a second combined wall defined by the second washer 232 and a third side wall 402 of the second housing 108. The second washer 232 may be fitted into an annular recess defined in the third side wall 402. In combination with an engagement between the first washer 214 and the first lip 223, engagements of opposite sides of the first bearing 230 with the second lip 225 and the second combined wall respectively, limits axial movement of the first bearing 230 during the operation of the of coupling assembly 100. Concurrently, an axial movement of the first gear 232 is limited by: (1) engagements of opposite sides of the first washer 214 with the first housing end-face 206 and the first lip 223 respectively; and (2) the engagement between the first bearing 230 and the second lip 225.

According to an aspect of the present disclosure, each of the first and second washers 214, 232 may be a thrust washer. The first bearing 230 and the first and second washer 214, 232 may dynamically limit (i.e. absorb and limit the transmission of) movement of the first gear 110 along the translational axis 350. Further, each of the first and second washers 214, 232 may be coated with a friction reducing coating, and/or formed of a material for which a coefficient of friction therewith is small (e.g. brass), to allow for relative rotational movement of the first gear 110.

With further reference to FIG. 4A, the second housing 108 is attached to the first housing 106 via the first set screws 242 positioned in the aligned first attachment, spacer, and second attachment bores 208, 212, 240 of the coupling assembly 100. By virtue of the configuration discussed above, transmission of movement, either rotational or axial, from the moving components of the coupling assembly 100 to the first and second housings 106, 108 is minimized, if not eliminated during the operation of the coupling assembly 100. This aspect of the present disclosure is further advantaged during the operation of the coupling assembly 100, by a configuration of the first shaft 102, the plug 244, and the first housing 106.

FIG. 4A illustrates a state of the coupling assembly 100 before or after an operation of the coupling assembly 100 for which the first shaft 102 is respectively going to be moved from, or has been moved to, a fully inserted position within the first housing 106. As such, a beveled or spherical surface 410 of the plug head 246 may abut, or be positioned immediately adjacent to, an end wall 420 of the first housing 106. The end wall 420, along with the first inner circumferential wall 422 defined by the first housing body 208, define a first housing cavity 424 through which the combined first shaft 102 and plug 244 moves. The threaded body 248 of the plug 244 is threaded on to the second threaded inner surface 252 of the first shaft 102 such that a flat surface 412 of the plug head 244 may engage a distal end 430 of the first shaft 102. The plug head 246 has formed thereon a rim 414, axially between the beveled or spherical surface 410 and the flat surface 412. The rim 414 may have a diameter slightly less than a diameter of the first inner circumferential wall 422 so that the plug 244 may slide along the first inner circumferential wall 422 of the first housing 106.

The plug 244 is configured to guide the movement of the first shaft 102 within the first housing 106 and maintain a coaxial alignment between the first shaft body 250 and the first housing body 208. Thus, the plug 244 prevents the first shaft body 250 from drifting toward a side of first inner circumferential wall 422 (e.g. a bottom side) as the first shaft 102 progresses through the first housing 106. Such drifting may cause the first shaft body 250 to come in contact with first inner circumferential wall 422 in an unbalanced manner and impede movement of the first shaft 102, and cause the first shaft 102 to apply a torque to the components in second housing including the first gear 110. In addition, because the rim 414 has a greater diameter than an outer diameter of the threaded external surface 254 of the first shaft 102, the outermost surface of the first shaft body 250 may not contact (e.g. uniformly slide against) the first inner circumferential wall 422 of the first housing 106. Thus, a frictional surface area between the first shaft 102 and the first housing 106 is limited to the rim 414 of the plug 244. Accordingly, frictional resistance to the movement of the first shaft 102, as well as transmission of movement from the first shaft 102 to the first housing 106, is minimized. Further, wear to the threaded external surface 254 is reduced over time, and an operational life of the coupling assembly 100 may be optimized as a result.

As the movements of the first gear 110, the second gear 270, and the first shaft 102 are in effect, isolated from the first and second housings 106, 108, little or no force is required to maintain the coupling assembly 100 in a position to engage a tool, in particular a power driver, and be continuously operated without necessitating attempts by an operator to prevent the assembly from twisting away from the tool (by gripping a lever arm/handle bar or implementing other methods). Accordingly, while loads are connected in tension via respective connections with the screws 118 or with other devices (e.g. hooks) attached to the screws 118, an operator can operate the drive assembly 112 with a tool and the coupling assembly 100 will not move, or be required to be held with substantial effort so the tool remains engaged with the second shaft 116 and thereby the drive assembly 112. In other words, the coupling assembly 100 will not move away from the tool to the point of disengagement as a result of the movements of the components of the coupling assembly 100. Thus, the coupling assembly 100 can be used quickly because an operator: (1) does not have repeatedly reengage the tool with the second shaft 116; (2) does not risk physical injury trying to secure a twisting assembly housing; and (3) may be less likely to have to rest multiple times as a result of becoming fatigued from having to hold the coupling assembly 100 during an operation.

FIG. 4B illustrates a sectional view of an implementation of the coupling assembly of FIG. 1A, taken upon the plane indicated by section line 4-4. In particular, FIG. 4B illustrates the second shaft 116 and second gear 270 of the drive assembly 112 being driven in a first rotational direction 440 (clockwise). In turn the first gear 110 is driven to rotate in a second rotational direction 450. Accordingly, the first threaded inner surface 228 rotates in the second rotational direction 450, and the threads of the first threaded inner surface 228 engage and axially displace threads of the threaded external surface 254 of the first shaft 102. As a result, the first shaft moves in an axial direction 460 corresponding to the direction of axial displacement of the threads of the thread external surface 254.

More simply, the second shaft is driven in a clockwise direction (first rotational direction 440), which causes the first gear 110 to rotate in a direction away from the plane indicated by section line 4-4 (second rotational direction 450). Rotation of the first gear 110 causes the shaft 102 to move in a direction away from (axial direction 460) the end wall 420 of the first housing 106 via the threaded engagement between the first gear 110 and the first shaft 102. As the first shaft 102 moves through the first housing 106, the rim 414 of the plug 244 slides along the first inner circumferential wall 422 and guides the movement of the first shaft 102.

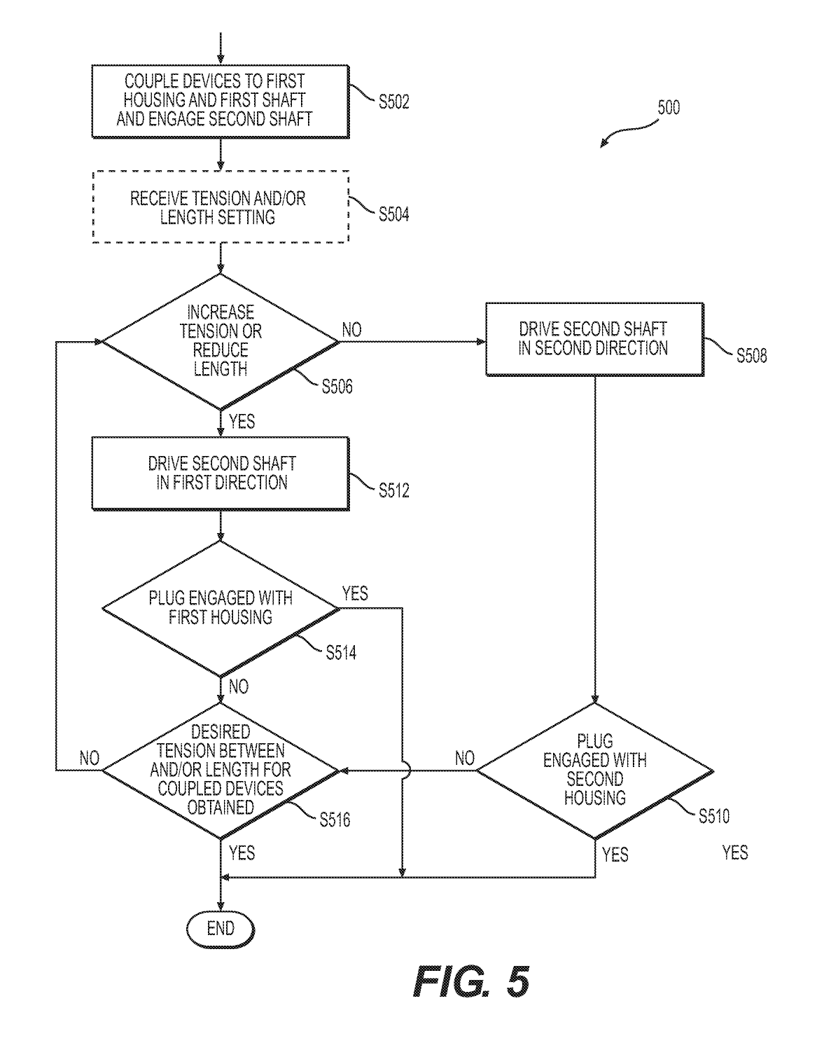

FIG. 5 is a flowchart illustrating an exemplary method 500 of implementing a coupling assembly, according to an aspect of the present disclosure. In block S502, each of screws 118 of the coupling assembly 100 may be connected to a device, such as cable, chain, or rod, that is attached to a load, such as a ship or vehicle; and the second shaft 116 may be engaged by a tool. The exemplary method 500 may include an optional process of receiving a desired tension or length between loads attached to the devices that are attached to the coupling assembly 100 in block S504. According to an aspect of the present disclosure, the second shaft 116 may be operated by a system that is capable of receiving a desired tension or length between loads attached to the coupling assembly 100. The system may autonomously operate the second shaft 116 utilizing positional and force sensors attached to the first shaft 102 (e.g. the plug) and first and second housings 106, 108, to achieve a setting inputted to the system.

In block S506, it may be determined whether a tension or length between loads is to be increased or reduced. If it is determined that the tension needs to be reduced/length increased, the second shaft 116 of the drive assembly 112 is driven in a first direction in block S508 to move the first shaft 102 in an axial direction away from the first housing 106, as in FIG. 4B. In block S510 it is determined whether the plug 244 is in contact with the second housing 108.

If it is determined that the tension/length needs to be increased/reduced in length, the second shaft 116 of the drive assembly 112 is driven in a second direction in block S512 to move the first shaft 102 in an axial direction toward the first housing 106. In block S514 it is determined whether the plug 244 is in contact with the end wall 420 of the first housing 106.

If it is determined in blocks S510 or S514 that the plug 244 is in contact with the second housing 108 or the end wall 420 respectively, the method 500 may end. On the other hand, if it is determined in blocks S510 or S514 that the plug 244 is not in contact with the second housing 108 or the end wall 420 respectively, whether or not a desired tension/length between the connected loads will be evaluated in block S516. A result of the evaluation could result in the end of the method 500 or a determination in block S506 of whether the tension should be increased/length decreased between the connected loads.

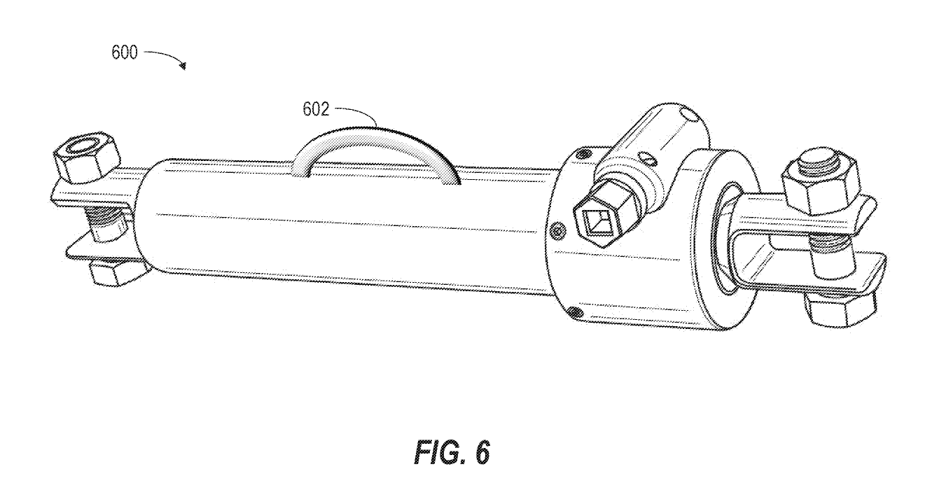

FIG. 6 illustrates a perspective view of a coupling assembly 600, according to an aspect of the present disclosure. The coupling assembly 600 of FIG. 6 includes all the features of a coupling assembly described herein, as well as a handle 602. The handle 602 may be used by an operator to initially locate and engage a drive assembly with a tool, such as a power driver or wrench. However, as discussed herein, such an operation of a coupling assembly according to the present disclosure does not result in rotational and axial movements of components of the coupling assembly being transmitted to respective housings. Accordingly, use of the handle 602 is not necessary to maintain a tool, such as a power driver, engaged with a drive assembly during an operation of the coupling assembly according to the present disclosure. In addition to aiding in an initial engagement with a drive assembly, the handle 602 provides a convenient means for carrying a coupling assembly to a particular location for use thereof.

It will be appreciated that the foregoing description provides examples of the disclosed coupling assembly and techniques for implementing the coupling assembly. These examples given above are merely illustrative and are not meant to be an exhaustive list of all possible designs, aspects, applications or modifications of the disclosure. Further, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A coupling assembly, the coupling assembly comprising:
a first shaft;
a first housing including a first housing body that defines a first housing cavity configured to receive the first shaft;
a second housing including a second housing body that defines a second housing bore, the second housing configured to attach to the first housing;
a first gear positioned in the second housing bore and configured to engage the first shaft proximate to the first housing cavity;
a first bearing positioned between the first gear and the second housing body within the second housing bore;
a third housing including a third housing body that defines a main cavity and at least one peripheral cavity;
a second gear positioned in the main cavity and configured to engage the first gear;
a second shaft extending through the main cavity and the at least one peripheral cavity, the second shaft configured to engage the second gear; and
a second bearing positioned between the second shaft and a wall of the third housing body that defines one of the main cavity and the at least one peripheral cavity,
wherein the second shaft rotates relative to the third housing and causes the first gear to drive the first shaft in an axial movement relative to the first housing and the second housing.

2. The coupling assembly according to claim 1,
wherein a first gearing component of the first gear defines a worm gear and a second gearing component of the second gear defines a worm,
wherein the first gear and the second gear define a worm drive.

3. The coupling assembly according to claim 1,
wherein the second housing body defines a gear slot configured to receive the second gear, and
wherein a surface that defines the gear slot engages the second bearing.

4. The coupling assembly according to claim 1,
wherein the second bearing includes a pair of second bearings positioned on the second shaft on opposite sides of the second gear, and
wherein each of the second bearings engages a respective side of the second gear and a respective side wall defined by the second housing body.

5. The coupling assembly according to claim 4, further comprising:
a pair of third bearings configured to support a rotation of the second shaft relative to the third housing,
wherein the second shaft extends through each of the pair of third bearings, and
wherein each of the pair of the third bearings is positioned on a respective side of the second gear.

6. The coupling assembly according to claim 5,
wherein each of the pair of third bearings is received within a respective annular wall defined by the third housing body, and
wherein each of the pair of third bearings engages a respective one of the pair of second bearings and a respective recessed wall that is defined by the second housing body.

7. The coupling assembly according to claim 5,
wherein each of the pair of second bearings is a thrust bearing, and
wherein each of the pair of third bearings is a roller bearing.

8. The coupling assembly according to claim 1,
wherein the first gear includes a first gearing component disposed between a first lip and a second lip extending from a first cylindrical portion of the first gear,
wherein the first bearing is positioned in the second housing such that the first gearing component, the first lip, and the second lip are spaced from and do not engage an inner circumferential wall of the second housing.

9. The coupling assembly according to claim 8, further comprising:
a washer positioned along a translational axis between the first gear and a housing end-face of the first housing,
wherein the first gear rotates about the translational axis, and
wherein the first lip engages the washer and the second lip engages the first bearing and thereby locates the first gearing component along the translational axis.

10. The coupling assembly according to claim 8,
wherein the first gear includes a threaded inner surface configured to engage a threaded external surface of the first shaft, and
wherein the first gear rotates relative to first shaft and the threaded inner surface of the first gear continuously axially displaces the threaded external surface of the first shaft.

11. The coupling assembly according to claim 1, further comprising:
a plug including a plug head,
wherein the plug is attached to the first shaft at a distal end of the first shaft, and
wherein the plug is configured to slide relative to an inner circumferential wall of the first housing and guide a movement of the first shaft along a translational axis.

12. The coupling assembly according to claim 11,
wherein a rim of the plug head engages the inner circumferential wall and has a diameter greater than an outer diameter of an external threaded surface of the first shaft such that the external threaded surface is spaced from the inner circumferential wall of the first housing, and
wherein the first gear surrounds the external threaded surface such that the external threaded surface is spaced from an inner circumferential wall of the second housing.

13. A method of coupling two loads, the method comprising:
providing a coupling assembly;
attaching a first housing of the coupling assembly to one of the two loads;
attaching a first shaft of the coupling assembly to the other of the two loads; and
operating a drive assembly of the coupling assembly to adjust a tension between the two loads,
wherein providing the coupling assembly includes providing:
a second housing attached to the first housing,
a first gear positioned in the second housing,
a threaded engagement between the first shaft and the first gear,
a first bearing positioned between the first gear and an inner circumferential wall of the second housing and configured to support a rotation of the first gear relative to the second housing,
a third housing attached to the second housing,
a second gear positioned in the third housing and engaged with the first gear through a gear slot defined by the second housing, and
at least one bearing positioned between a second shaft of the drive assembly and a recessed wall of the second housing, and
wherein operating the drive assembly includes rotating the second shaft of the drive assembly.

14. The method according to claim 13,
wherein operating a drive assembly includes sliding a plug attached to the first shaft relative to an inner circumferential wall of the first housing to guide a movement of the first shaft along a translational axis.

15. The method according to claim 13,
wherein operating the drive assembly includes driving an axial movement of the first shaft with a direct threaded engagement between the first shaft and the first gear.

16. The method according to claim 13,
wherein operating the drive assembly includes rotating the second shaft in a clockwise direction to decrease the tension between the two loads.

17. A coupling assembly, the coupling assembly comprising:
a first shaft including a threaded external surface and a threaded internal surface;
a plug including a plug head and a threaded body engaged with the threaded internal surface;
a first housing including a first housing body that defines a first housing cavity configured to receive the first shaft;
a second housing including a second housing body that defines a second housing bore;
a first gear positioned in the second housing bore and engaged with the threaded external surface;
a first bearing positioned between the first gear and the second housing body within the second housing bore;
a third housing including a third housing body that defines a main cavity and a peripheral cavity on opposite sides of the main cavity;
a second gear positioned in the main cavity and engaged with the first gear;
a second shaft extending through the main cavity and each peripheral cavity, the second shaft being engaged with the second gear; and
a pair of bearings positioned in the third housing, each of the pair of bearings being positioned in a respective peripheral cavity between the second shaft and third housing body,
wherein the second shaft rotates relative to the third housing and causes the first gear to drive the first shaft in an axial movement relative to the first housing and the second housing.

18. The coupling assembly according to claim 17,
wherein the plug is configured to slide relative to the first housing and a rim of the plug head engages an inner circumferential wall of the first housing, the rim having a diameter greater than an outer diameter of the external threaded surface of the first shaft.

19. The coupling assembly according to claim 17,
wherein the second shaft includes a drive shaft engaged with the second gear and the pair of bearings,
wherein the second shaft includes a drive head extending from the drive shaft, and
wherein the drive head defines a shaped recess that is accessible from an outside of the third housing and is configured to receive a tool.

20. The coupling assembly according to claim 17,
wherein the second housing body defines a gear slot configured to receive the second gear, and
wherein each of the pair of bearings engages a surface of the second housing disposed on a respective side of the gear slot.
